(19) United States
(12) Patent Application Publication
(10) Pub. No.: US 2023/0212902 A1
(43) Pub. Date: Jul. 6, 2023

(54) MOTOR TYPE HINGE APPARATUS FOR DOOR

(71) Applicant: SEO WON KOREA CO., LTD, Gimhae-si (KR)

(72) Inventors: June Young LEE, Busan (KR); Kyoung Rok KIM, Busan (KR)

(21) Appl. No.: 18/115,171

(22) Filed: Feb. 28, 2023

Related U.S. Application Data
(63) Continuation of application No. PCT/KR2020/018011, filed on Dec. 10, 2020.

(30) Foreign Application Priority Data
Sep. 9, 2020 (KR) 10-2020-0115299

(51) Int. Cl. E05F 15/611; E05F 1/10; D06F 39/14

(52) U.S. Cl. CPC E05F 15/611; E05F 1/105; D06F 39/14; E05Y 2201/434; E05Y 2201/474; E05Y 2201/626; E05Y 2201/686; E05Y 2800/205; E05Y 2800/236; E05Y 2800/43; E05Y 2900/312

(57) ABSTRACT

The disclosure relates to motor type hinge apparatus for a door, which can reduce load of a motor when a door of a washing machine is opened and closed, and of opening and closing the door even with less load of the motor. The motor type hinge apparatus includes a housing provided at a main body of an appliance that is equipped with a door, a motor assembly including a shaft, a joint, and a motor, a cam provided in the housing, and including a first hole and a second hole respectively formed at first and second ends thereof, a cam link including a second link hole and a first link hole respectively formed at first and second ends thereof, and a lever including a lever hole, a rod, and first and second steps.

### REFERENCE TO RELATED APPLICATIONS

This is a continuation of International Patent Application PCT/KR2020/018011 filed on Dec. 10, 2020, which designates the United States and claims priority of Korean Patent Application No. 10-2020-0115299 filed on Sep. 9, 2020, the entire contents of which are incorporated herein by reference.

### FIELD OF THE INVENTION

The present disclosure relates to motor type hinge apparatus for a door. More particularly, the present disclosure relates to motor type hinge apparatus for a door, the apparatus being capable of reducing load of a motor when a door of a washing machine is opened and closed, and of opening and closing the door even with less load of the motor.

### BACKGROUND OF THE INVENTION

In general, appliances such as home appliances and furniture having a door are provided with a door that is hinged to a main body and opens and closes the main body. As the door is rotated, the main body may be opened and closed.

Among the home appliances, a washing machine is divided into a washing tub rotary washing machine in which laundry is loaded from the top and a drum type washing machine in which laundry is loaded from the front. In the case of the washing tub rotary washing machine, the washing machine is configured to be opened and closed by opening and closing a door provided at an upper portion of the washing machine.

When the door of such washing machine is opened and closed, there is a demand for the development of a hinge that can easily open and close the door and allow smooth opening and closing of the door. In addition, there is a demand for the development of a hinge that can stably support the load of the door and allow smooth rotation.

### SUMMARY OF THE INVENTION

Accordingly, the present disclosure has been made keeping in mind the above problems occurring in the related art, and the present disclosure is intended to provide motor type hinge apparatus for a door, the apparatus being capable of reducing load of a motor when a door of a washing machine is opened and closed.

Furthermore, the present disclosure is intended to provide motor type hinge apparatus for a door, the apparatus being capable of easily opening and closing a door even with less load of a motor.

In addition, other objectives and advantages of the present disclosure will be described below, and it may be encompassed in a broader scope by means and combinations within the scope that can be easily derived from the disclosure of the matters and embodiments described in the claims of the present disclosure.

In order to achieve the above objectives, according to one aspect of the present disclosure, there is provided motor type hinge apparatus for a door, the motor type hinge apparatus including: a housing provided at a main body of an appliance that may be equipped with a door; a motor assembly including a shaft, a joint, and a motor, wherein the shaft may be inserted into a first groove, which may be provided at a second end of the housing, to be connected to the door, the joint may be rotatably connected to the shaft, and the motor may be connected to the joint; a cam provided in the housing, and including a first hole and a second hole, wherein the first hole is formed at a first end of the cam to correspond to the first groove and in which the shaft is inserted and fixed and the second hole is formed at a second end thereof, the cam being configured to be rotated on the first hole when the door is opened; a cam link including a second link hole and a first link hole, wherein the second link hole may be formed at a first end of the cam link to correspond to the second hole and the first link hole may be formed at a second end thereof, the cam link being configured to move forward by the cam that rotates when the door is opened; and a lever including a lever hole, a rod, and first and second steps, wherein the lever hole may be formed at a second end of the lever to correspond to the first link hole, the rod may be inserted into a spring, and the first and second steps may be provided at the a second end of the rod to prevent the spring from being separated, the lever being configured to move linearly in a second direction based on the lever hole by the cam link that may move forward when the door is opened.

A section shape of the shaft and a shape of the first hole may be formed such that transverse lengths of the shapes may be longer than longitudinal lengths thereof, and when the shaft is rotated with opening of the door, the first hole may be rotated together so that the cam may be rotated.

The motor type hinge apparatus may include: a first rivet inserted into a second groove provided at a first end of the housing, and provided to prevent the spring from being separated toward a front surface of the housing; second and third rivets provided to be caught by the first and second steps of the lever inside the housing, and configured to guide linear movement of the lever; a fourth rivet connecting the second hole of the cam to the second link hole of the cam link inside the housing; a fifth rivet connecting the first link hole of the cam link to the lever hole of the lever; and a guide groove formed in a portion in the housing, the portion corresponding to the fourth rivet so that the fourth rivet may curve when the cam is rotated with opening of the door.

As described above, the present disclosure can provide the following effects.

When the door of the washing machine is opened and closed, load of the motor can be reduced, and the door can be opened and closed even with less load of the motor.

In other words, as the problem that the door is not opened because load of the motor is not enough when the door is opened is solved, the door can be opened easily with only less load of the motor, by force of the spring.

Furthermore, the problem that the door falls down when the door is closed can be prevented, and load of the motor can be reduced.

In addition, other effects of the present disclosure can be broader by not only the embodiments described above and disclosure in the claims of the present disclosure, but also by effects that can occur within the scope that can be easily followed from the embodiments and the accompanying claims and by possibilities of potential advantages contributing to industrial development.

### BRIEF DESCRIPTION OF THE DRAWINGS

FIGS. 1A to 1C are views showing a door opening state of a washing machine equipped with motor type hinge apparatus for a door according to the present disclosure.

FIGS. 2A to 2C are views showing the motor type hinge apparatus for a door according to the present disclosure.

FIGS. 3A and 3B are views showing the motor type hinge apparatus for a door according to the present disclosure when the door is opened and closed.

### DETAILED DESCRIPTION OF THE INVENTION

Hereinbelow, a preferred embodiment of the present disclosure will be described in detail with reference to the accompanying drawings. Prior to the description, advantages and features of the present disclosure and methods for achieving them will be more clearly understood from the following detailed embodiments with reference to the accompanying drawings. The terminology used herein is for the purpose of describing particular embodiments only and is not intended to be limiting of the present disclosure. As used herein, the singular forms are intended to include the plural forms as well, unless the context clearly indicates otherwise. A word indicating a direction is provided for the understanding of the description and may be changed on the basis of a viewpoint.

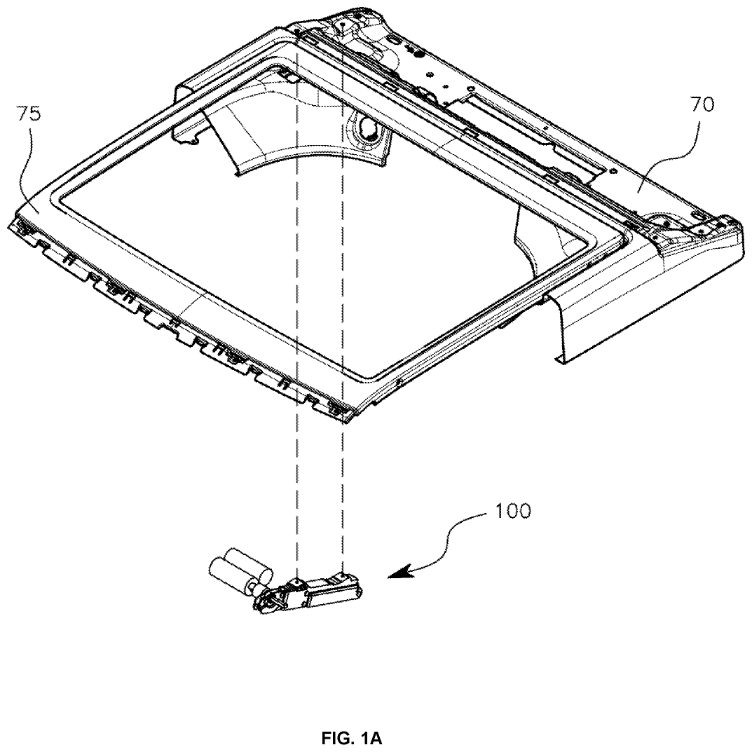

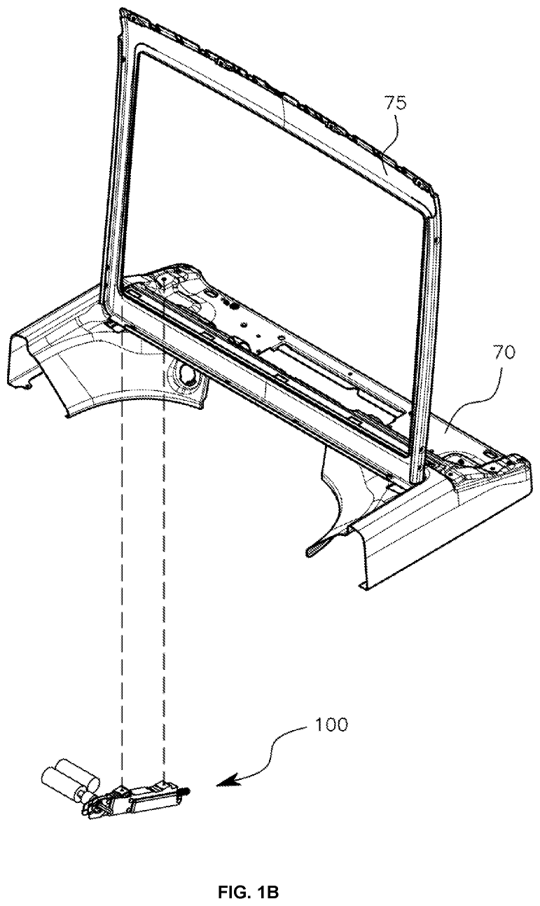

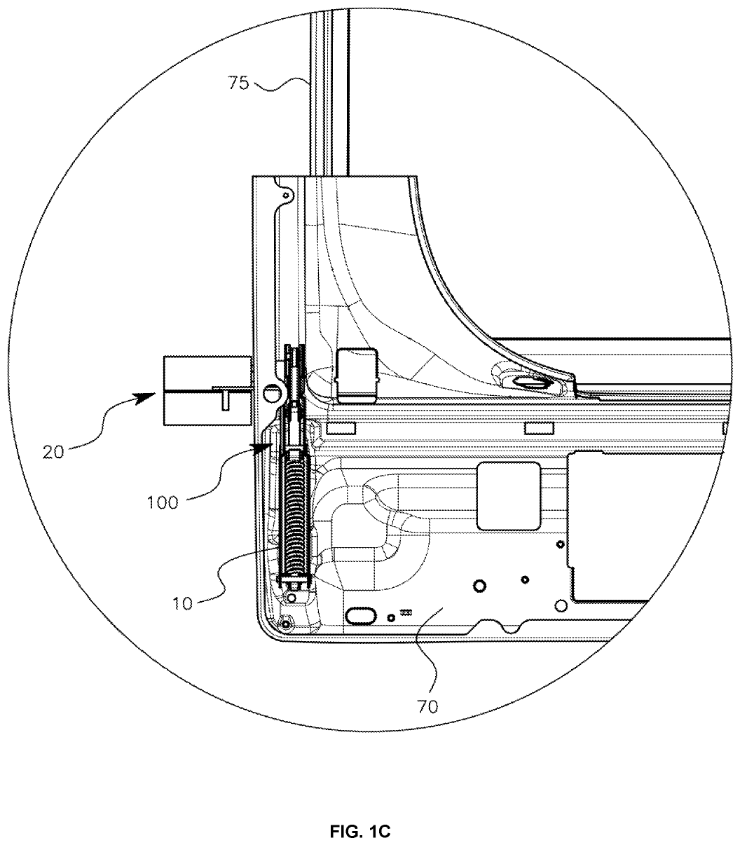

Hereinbelow, according to an exemplary embodiment of the present disclosure, a motor type hinge apparatus for a door will be described in detail with reference to accompanying drawings. FIGS. 1A to 1C are views showing a door opening state of a washing machine equipped with motor type hinge apparatus for a door according to the present disclosure.

Referring to FIGS. 1A to 1C, according to the present disclosure, a motor type hinge apparatus 100 for a door is provided in a washing machine. FIG. 1A is a view showing a door 75 of the washing machine in a closed state. FIG. 1B is a view showing the door 75 of the washing machine in an opened state. FIG. 1C is an enlarged view showing a portion of the washing machine, the portion having the motor type hinge apparatus 100 for a door.

According to the present disclosure, the motor type hinge apparatus 100 for a door is provided in the washing machine. Specifically, as shown in FIG. 1C, a motor assembly 20 protrudes outward from a washing machine main body 70, and a housing 10 is provided inside the washing machine main body 70. Furthermore, a shaft provided in the housing 10 is connected to the door 75 of the washing machine.

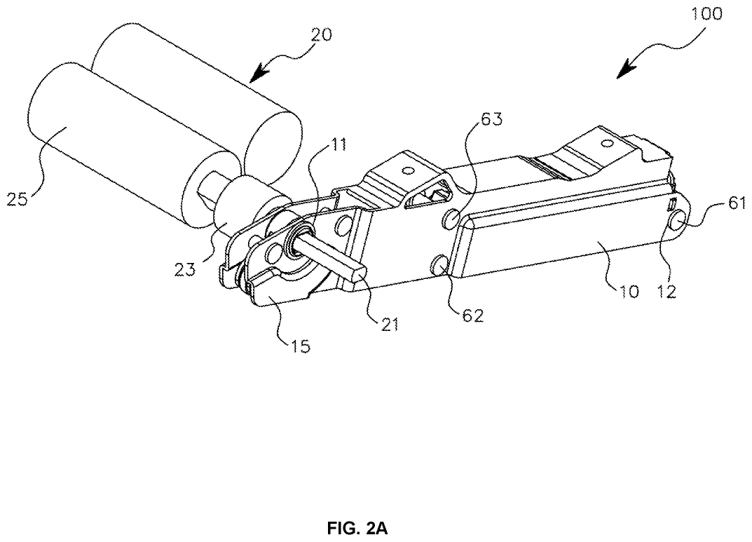

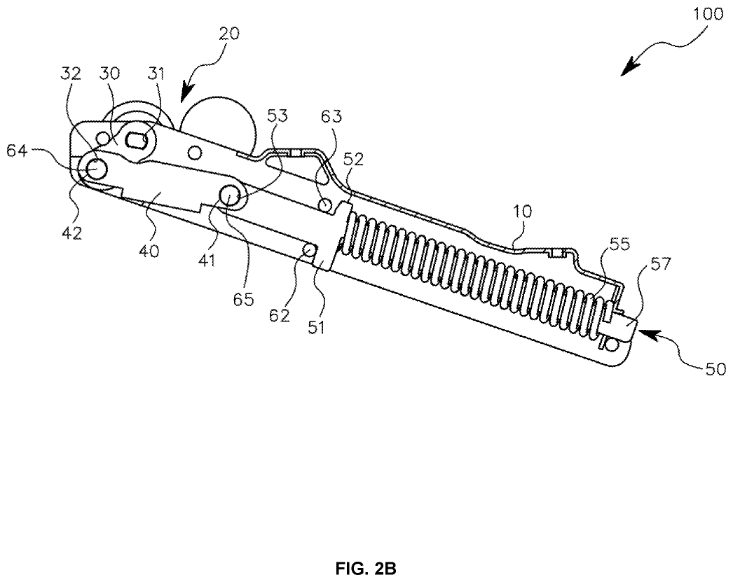

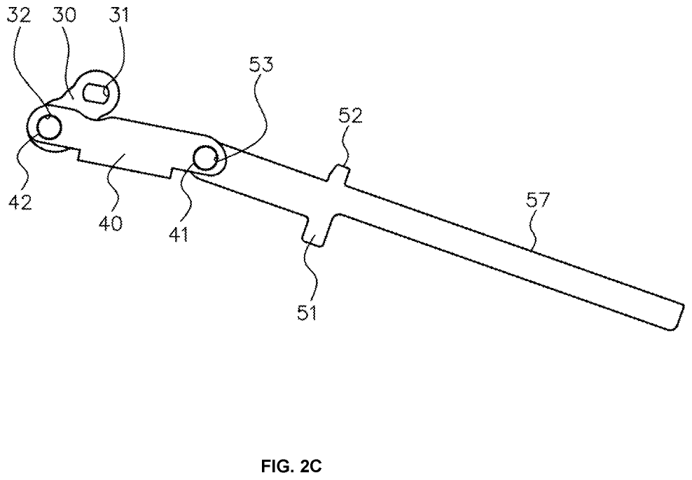

Referring to FIGS. 2A to 2C, the motor type hinge apparatus 100 for a door according to the present disclosure will be described in detail. According to the present disclosure, the motor type hinge apparatus 100 for a door includes the housing 10, the motor assembly 20, a cam 30, a cam link 40, and a lever 50.

The housing 10 is provided at a main body 70 of an appliance with the door 75, e.g. a washing machine. As shown in FIGS. 1A to 1C, the housing 10 may be securely provided inside an upper portion of the main body 70 of the washing machine. The housing 10 includes a first groove 11 provided at a second end of the housing and a second groove 12 provided at a first end thereof. A first hole 31 of the cam 30 to be described below is provided at a portion corresponding to the first groove 11 of the housing 10, and a shaft 21 of the motor assembly 20 to be described is inserted in the first groove 11 and the first hole 31. A first rivet 61 is inserted into the second groove 12 of the housing 10.

The motor assembly 20 includes the shaft 21, a joint 23, and a motor 25. The motor 25 is provided to open and close the door 75. The motor 25 may be provided outside the upper portion of the main body 70 of the washing machine. In the embodiment, an example that the motor 25 includes two motors is shown, but the present disclosure is not limited thereto. The motor 25 is connected to the housing 10 via the joint 23. The joint 23 is provided inside the main body 70 of the washing machine, and only the motor 25 may be provided outside the main body 70.

The shaft 21 connects the motor 25 to the joint 23, and is inserted into the first groove 11 of the housing 10 described above. In addition, the first hole 31 of the cam 30 is provided at a portion corresponding to the first groove 11 inside the housing 10, so that the shaft 21 is inserted into the first groove 11 and the first hole 31. At this point, the shaft 21 is securely inserted in the first hole 31. A section shape of the shaft 21 and a shape of the first hole 31 may be formed such that, as shown in the drawings, transverse lengths of the shapes are longer than longitudinal lengths thereof. By the shapes, when the door 75 is opened, the shaft 21 can be efficiently rotated. When the shaft 21 is rotated with opening of the door 75, the first hole 31 is rotated together and the cam 30 having the first hole 31 is rotated.

The cam 30 is provided inside the housing 10. The cam 30 includes the first hole 31 and a second hole 32. The first hole 31 is formed at a first end of the cam 30, and the first hole 31 is provided to correspond to the first groove 11 of the housing 10 as described above, and the shaft 21 is inserted into the first hole 31. At this point, the shaft 21 is securely inserted in the first hole 31. The second hole 32 is provided at a second end of the cam 30, and the second hole 32 is provided to correspond to a second link hole 42 of the cam link 40 to be described below and is connected to the second link hole 42 with the fourth rivet 64.

When the door 75 is opened, the first hole 31 of the cam 30 is rotated together by rotation of the shaft 21, so that the second end of the cam 30 is rotated on the first hole 31. When the door 75 is opened, the second end of the cam 30, e.g., the fourth rivet 64 is rotated. At this point, a guide groove 15 guiding the fourth rivet 64 to curve is provided in an internal portion of the housing 10 corresponding to the fourth rivet 64.

The cam link 40 is provided inside the housing 10. The cam link 40 includes a first link hole 41 and the second link hole 42. The first link hole 41 is provided at a second end of the cam link 40, and is connected to the lever 50, which will be described below. The second link hole 42 is provided at a first end of the cam link 40, and as described above, the second link hole 42 is connected to the cam 30 via the second hole 32 of the cam 30.

The cam link 40 moves forward by the cam 30 that is rotated when the door 75 is opened. In other words, when the fourth rivet 64 moves along the guide groove 15 while the second end of the cam 30 is rotated, the cam link 40 moves forward to a front end of the housing 10 by power of the movement.

The lever 50 is provided inside the housing 10. The lever 50 includes first and second steps 51 and 52, a lever hole 53, a spring 55, and a rod 57. The lever hole 53 is formed at a second end of the lever 50, and corresponds to the first link hole 41 described above. The lever hole 53 and the first link hole 41 are connected to each other with a fifth rivet 65, so that the cam link 40 and the lever 50 are rotatably connected to each other.

The rod 57 is inserted in the spring 55. The first and second steps 51 and 52 are provided to prevent the spring 55 from being separated from a second end of the rod 57. The spring 55 is fitted over the rod 57, and is prevented from being separated from the lever 50 by the second steps 51 and 52 and the first rivet 61.

The first and second steps 51 and 52 are provided to be caught by second and third rivets 62 and 63 so as to prevent the lever 50 from being separated from the inside of the housing 10.

By the cam link 40 moving forward when the door 75 is opened, the lever 50 moves linearly in a second direction based on the lever hole 53. In other words, when the door is opened, the shaft 21 inserted in the first hole 31 is rotated on the first groove 11, and the cam 30 is rotated by rotation of the first hole 31. As the cam 30 is rotated, the cam link 40 moves forward with the second link hole 42 connected to the second hole 32 of the cam 30. As the cam link 40 moves forward, the lever 50 moves forward with the lever hole 53 connected to the first link hole 41, and the lever 50 moves linearly in the second direction of the housing 10.

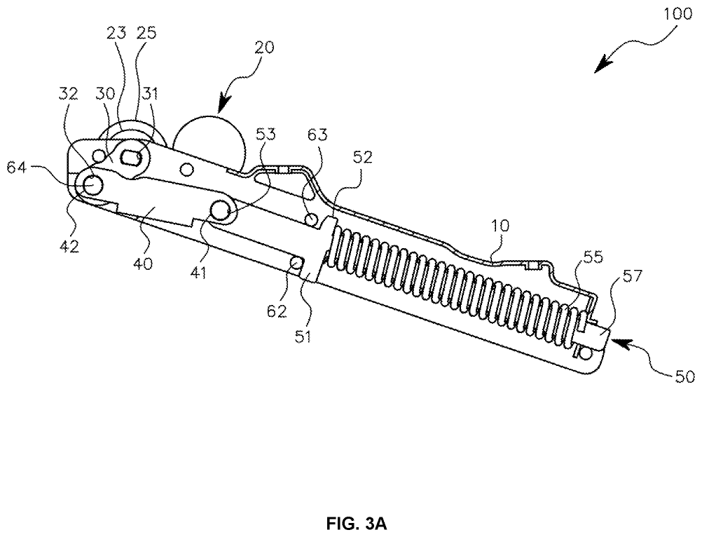

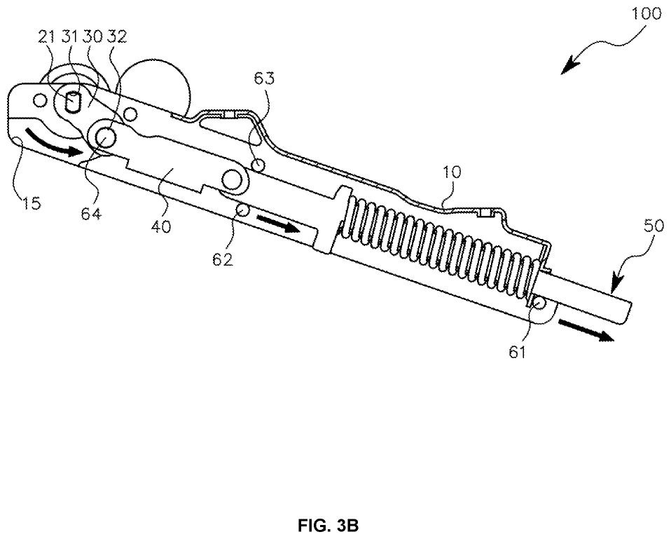

Hereinbelow, with opening and closing of the door according to the embodiment, an operational state of the motor type hinge apparatus 100 for a door will be described in detail. FIGS. 3A and 3B are views showing the motor type hinge apparatus for a door according to the present disclosure when the door is opened and closed.

FIG. 3A is a closed state of the door, and FIG. 3B is an opened state of the door.

Referring to FIG. 3A, when the door is closed, the shaft 21 connected to the motor 25 of the motor assembly 20 via the joint 23 is inserted in the first hole 31 of the cam 30, the cam 30 is connected to the cam link 40 via the second hole 32 and the second link hole 42, and the cam link 40 is connected to the lever 50 via the first link hole 41 and the lever hole 53. The first and second steps 51 and 52 of the lever 50 is caught by the second and third rivets 62 and 63, and the first and second steps 51 and 52 and the first rivet 61 prevent separation of the spring 55 from the inside of the housing 10.

Referring to FIG. 3B, when the door is opened, the shaft 21 connected to the door is rotated, and the first hole 31 of the cam 30 connected to the shaft 21 is rotated on the first groove 11, and as shown by the arrow, the second hole 32 of the cam 30 is rotated along the guide groove 15. As the second link hole 42 connected to the second hole 32 is rotated with rotation of the cam 30, the cam link 40 moves forward as shown by the arrow, and the lever hole 53 connected to the first link hole 41 of the cam link 40 is rotated so that the lever 50 moves forward as shown by the arrow.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims. Therefore, the embodiments of the present disclosure are intended to described, without limiting the technical ideas of the present disclosure, and the technical ideas of the present disclosure are not limited by the embodiments. The scope of the present disclosure will be interpreted by the accompanying claims, and those skilled in the art should understand that all technical ideas within equivalent scope should be included in the scope of the present disclosure.

### DESCRIPTION FOR REFERENCE NUMERALS

100; motor type hinge apparatus for door
10; housing
11, 12; groove
15; guide groove
20; motor assembly
21; shaft
23; joint
25; motor
30: cam
31, 32; hole
40; cam link
41, 42; link hole
50; lever
51, 52; step
53; lever hole
55; spring
57; rod
61, 62, 63, 64, 65; rivet

What is claimed is:

1. A motor type hinge apparatus for a door, the motor type hinge apparatus comprising:
a housing provided at a main body of an appliance that is equipped with a door;
a motor assembly comprising a shaft, a joint, and a motor, wherein the shaft is inserted into a first groove, which is provided at a second end of the housing, to be connected to the door, the joint is rotatably connected to the shaft, and the motor is connected to the joint;
a cam provided in the housing, and comprising a first hole and a second hole, wherein the first hole is formed at a first end of the cam to correspond to the first groove and in which the shaft is inserted and fixed and the second hole is formed at a second end thereof, the cam being configured to be rotated on the first hole when the door is opened;
a cam link comprising a second link hole and a first link hole, wherein the second link hole is formed at a first end of the cam link to correspond to the second hole and the first link hole is formed at a second end thereof, the cam link being configured to move forward by the cam that rotates when the door is opened; and
a lever comprising a lever hole, a rod, and first and second steps, wherein the lever hole is formed at a second end of the lever to correspond to the first link hole, the rod is inserted into a spring, and the first and second steps are provided at the a second end of the rod to prevent the spring from being separated, the lever being configured to move linearly in a second direction based on the lever hole by the cam link that moves forward when the door is opened.

2. The motor type hinge apparatus of claim 1, wherein a section shape of the shaft and a shape of the first hole are formed such that transverse lengths of the shapes are longer than longitudinal lengths thereof, and
when the shaft is rotated with opening of the door, the first hole is rotated together so that the cam is rotated.

3. The motor type hinge apparatus of claim 1, further comprising:
a first rivet inserted into a second groove provided at a first end of the housing, and provided to prevent the spring from being separated toward a front surface of the housing;
second and third rivets provided to be caught by the first and second steps of the lever inside the housing, and configured to guide linear movement of the lever;
a fourth rivet connecting the second hole of the cam to the second link hole of the cam link inside the housing;
a fifth rivet connecting the first link hole of the cam link to the lever hole of the lever; and
a guide groove formed in a portion in the housing, the portion corresponding to the fourth rivet so that the fourth rivet curves when the cam is rotated with opening of the door.
